(19) United States
(12) Patent Application Publication
(10) Pub. No.: US 2010/0187804 A1
(43) Pub. Date: Jul. 29, 2010

(54) MULTIPURPOSE COVER SUPPORTER

(76) Inventor: Jeong Woo Park, Cheonan-si (KR)

Correspondence Address: CHRISTOPHER PAUL MITCHELL, 888 16TH ST., NW, SUITE 800, WASHINGTON, DC, 20006, US

(21) Appl. No.: 12/668,881

(22) PCT Filed: Jul. 11, 2008
(86) PCT No.: PCT/KR08/04113

§ 371 Date: Jan. 12, 2010

(30) Foreign Application Priority Data
Jul. 12, 2007 (KR) 10-2007-0069944
Sep. 19, 2007 (KR) 10-2007-0095042
Jan. 14, 2008 (KR) 10-2008-0003903
Jul. 7, 2008 (KR) 10-2008-0065329

(51) Int. Cl. B42D 17/00

(52) U.S. Cl. 281/45

(57) ABSTRACT

An eye protective cover capable of supporting multi-purpose contents is disclosed. The cover includes front and back covers (20 and 30) which are foldably coupled to each other by a main coupling part (10). Front and back collapsing covers (25 and 35) are coupled, respectively, to upper surfaces of the front and back covers (20 and 30) by separation lines (25a and 35a) in such a way as to overlap the front and back covers (20 and 30). An angle holding unit is provided between the front or back cover (20 or 30) and the corresponding front or back collapsing cover (25 or 35) to hold an angle between the front or back cover (20 or 30) and the corresponding front or back collapsing cover (25 or 35).

### TECHNICAL FIELD

The present invention relates, in general, to an eye protective cover, which is applicable to various types of products and, more particularly, to a cover capable of supporting multi-purpose contents, which has improved portability and utility.

### BACKGROUND ART

A product, including pages containing written matter and covers enclosing the pages on both sides, for example, a book, a notebook, a memo pad, an album, a picture book, a business-card arranger, a diary, a calendar, a catalogue of an insurance company or bank, and an electronic note, must be placed on a table in order to use or write on the pages on which written contents are printed. In this state, a user pulls his or her body forward and bows his or her head.

However, the posture of pulling the body towards the table and bowing one's head is a burden on the user's waist and eyes. Thus, when the posture is repeated for a lengthy period of time, a spinal disease, amblyopia, empyema, and the lowering of learning efficiency may ensue.

### DISCLOSURE OF INVENTION

### Technical Problem

Accordingly, the present invention has been made keeping in mind the above problems occurring in the prior art, and an object of the present invention is to provide an eye protective cover capable of supporting multi-purpose contents, which can be used without bending the waist or head, thus maximizing convenient use thereof, in addition to improving its portability.

### Technical Solution

In order to accomplish the above object, according to one embodiment of the invention, the present invention provides an eye protective cover capable of supporting multi-purpose contents, including front and back covers 20 and 30 foldably coupled to each other by a main coupling part 10; front and back collapsing covers 25 and 35 coupled, respectively, to upper surfaces of the front and back covers 20 and 30 by separation lines 25a and 35a in such a way as to overlap the front and back covers 20 and 30; and an angle holding unit provided between the front or back cover 20 or 30 and the corresponding front or back collapsing cover 25 or 35 to hold an angle between the front or back cover 20 or 30 and the corresponding front or back collapsing cover 25 or 35.

Further, in order to accomplish the above object, according to another embodiment of the invention, the present invention provides an eye protective cover capable of supporting multi-purpose contents, including front and back covers 120 and 130 foldably coupled to each other by a main coupling part 110; a front collapsing cover 125 connected to an upper portion of the front cover 120 via a separation line 125a, thus overlapping the front cover 120; a back collapsing cover 135 connected to an upper portion of the back cover 130 via a separation line 135a, thus overlapping the back cover 130; a subsidiary coupling part 115 coupling the front collapsing cover 125 with the back collapsing cover 135; and an angle holding unit connected between the subsidiary coupling part 115 and the main coupling part 110, thus maintaining an angle between the front cover 20 and the front collapsing cover 125, and an angle between the back cover 130 and the back collapsing cover 135.

The above and other features and advantages of the present invention will be more clearly understood from the following detailed description taken in conjunction with the accompanying drawings. Here, the terminologies or words used in the description and the claims of the present invention should not be interpreted as being limited merely to common and dictionary meanings, but should be interpreted based on the meanings and concepts of the invention in keeping with the scope of the invention on the basis of the principle that the inventor can appropriately define the terms in order to describe the invention in the best way.

### ADVANTAGEOUS EFFECTS

An eye protective cover capable of supporting multi-purpose contents according to the present invention is advantageous in that the cover includes a front collapsing cover coupled to the upper surface of a front cover via a separation line, a back collapsing cover coupled to the upper surface of a back cover via a separation line, and an angle holding unit for holding an angle between the front or back cover and the front or back collapsing cover, thus allowing the cover to be closed and carried like a general book, and allowing the cover to be erected and used like a reading desk. Thus, a user can see written matter of a page unit without the necessity of bending the waist or head. Further, the cover allows the page unit to be easily replaced with another one, thus affording improved utility.

### BRIEF DESCRIPTION OF THE DRAWINGS

FIG. 1 is a perspective view illustrating an eye protective cover capable of supporting multi-purpose contents according to a first embodiment of the present invention,

FIG. 2 is a view illustrating a first embodiment of an angle holding unit for holding an angle between a front or back cover and a corresponding front or back collapsing cover in the eye protective cover of FIG. 1,

FIG. 3 is a side view illustrating the eye protective cover capable of supporting multi-purpose contents of FIG. 2,

FIG. 4 is a view illustrating a second embodiment of an angle holding unit for holding an angle between the front or back cover and the corresponding front or back collapsing cover in the eye protective cover of FIG. 1,

FIG. 5 is a view illustrating a third embodiment of an angle holding unit for holding an angle between the front or back cover and the corresponding front or back collapsing cover in the eye protective cover of FIG. 1,

FIGS. 6 and 7 are views illustrating a fourth embodiment of an angle holding unit for holding an angle between the front or back cover and the corresponding front or back collapsing cover in the eye protective cover of FIG. 1,

FIG. 8 is a view illustrating a fifth embodiment of an angle holding unit for holding an angle between the front or back cover and the corresponding front or back collapsing cover in the eye protective cover of FIG. 1,

FIGS. 9 and 10 are views illustrating a sixth embodiment of an angle holding unit for holding an angle between the front or back cover and the corresponding front or back collapsing cover in the eye protective cover of FIG. 1,

FIG. 11 is a view illustrating a seventh embodiment of an angle holding unit for holding an angle between the front or back cover and the corresponding front or back collapsing cover in the eye protective cover of FIG. 1,

FIG. 12 is a view illustrating an eighth embodiment of an angle holding unit for holding an angle between the front or back cover and the corresponding front or back collapsing cover in the eye protective cover of FIG. 1,

FIG. 13 is a view illustrating a ninth embodiment of an angle holding unit for holding an angle between the front or back cover and the corresponding front or back collapsing cover in the eye protective cover of FIG. 1,

FIG. 14 is a view illustrating a tenth embodiment of an angle holding unit for holding an angle between the front or back cover and the corresponding front or back collapsing cover in the eye protective cover of FIG. 1,

FIG. 15 is a detailed view illustrating the angle holding unit of FIG. 14,

FIG. 16 is a view illustrating an eleventh embodiment of an angle holding unit for holding an angle between the front or back cover and the corresponding front or back collapsing cover in the eye protective cover of FIG. 1,

FIG. 17 is a view illustrating a main coupling part of the eye protective cover of FIG. 1, in which the main coupling part comprises a plurality of rings,

FIG. 18 is a view illustrating the state in which the eye protective of FIG. 17 is closed like a book,

FIG. 19 is a view illustrating the front collapsing cover and the back collapsing cover which are separated from each other,

FIG. 20 is a view illustrating a subsidiary coupling part provided on each of the upper and lower ends of the front and back collapsing covers,

FIG. 21 is a view illustrating holes formed in a subsidiary coupling part,

FIGS. 22 and 23 are views illustrating the front and back collapsing covers fitting inside the corresponding front and back covers,

FIG. 24 is a perspective view illustrating an eye protective cover capable of supporting multi-purpose contents according to a second embodiment of the present invention, in which the eye protective cover has an angle holding unit of a first embodiment,

FIG. 25 is a view illustrating an angle holding unit of a second embodiment in the eye protective cover of FIG. 23, and

FIG. 26 is a view illustrating an angle holding unit of a third embodiment in the eye protective cover of FIG. 24.

### DESCRIPTION OF REFERENCE CHARACTERS OF IMPORTANT PARTS

10 . . . main coupling part 15 . . . subsidiary coupling part
15′ . . . subsidiary coupling band 20 . . . front cover
25 . . . front collapsing cover
25″ . . . front collapsing cover
30 . . . back cover 35 . . . back collapsing cover
35″ . . . back collapsing cover
40 . . . first embodiment of angle holding unit
140 . . . second embodiment of angle holding unit
240 . . . third embodiment of angle holding unit
340 . . . fourth embodiment of angle holding unit
440 . . . fifth embodiment of angle holding unit
540 . . . sixth embodiment of angle holding unit
640 . . . seventh embodiment of angle holding unit
740 . . . eighth embodiment of angle holding unit
840 . . . ninth embodiment of angle holding unit
940 . . . tenth embodiment of angle holding unit
1040 . . . eleventh embodiment of angle holding unit
110 . . . main coupling part
115 . . . subsidiary coupling part 120 . . . front cover
125 . . . front collapsing cover 130 . . . back cover
135 . . . back collapsing cover
1240 . . . first embodiment of angle holding unit
1340 . . . second embodiment of angle holding unit
1440 . . . third embodiment of angle holding unit
210 . . . main coupling part 220 . . . front cover
225 . . . front collapsing cover 230 . . . back cover
235 . . . back collapsing cover

### MODE FOR THE INVENTION

The above and other objects, features and advantages of the present invention will be more clearly understood from the following detailed description.

Hereinafter, an eye protective cover capable of supporting multi-purpose contents according to the present invention will be described with reference to the accompanying drawings.

Reference now should be made to the drawings, in which the same reference numerals are used throughout the different drawings to designate the same or similar components. For the clarity of description, known functions and constructions relating to the present invention will be omitted herein.

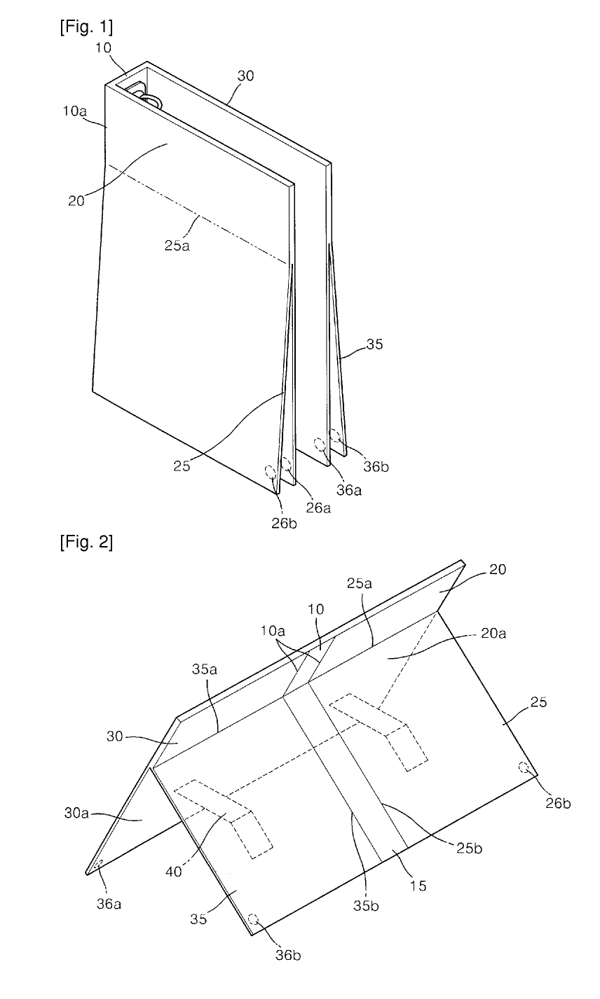

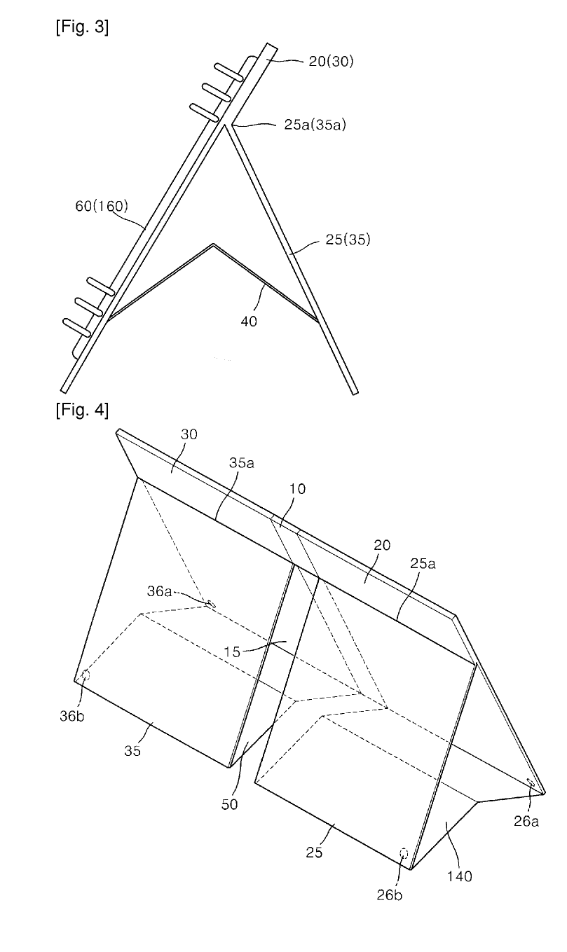

FIG. 1 is a perspective view illustrating an eye protective cover capable of supporting multi-purpose contents according to a first embodiment of the present invention, FIG. 2 is a view illustrating a first embodiment of an angle holding unit for holding an angle between a front or back cover and a corresponding front or back collapsing cover in the eye protective cover of FIG. 1, FIG. 3 is a side view illustrating the eye protective cover capable of supporting multi-purpose contents of FIG. 2.

As shown in the drawings, an eye protective cover capable of supporting multi-purpose contents according to the first embodiment of the present invention includes front and back covers 20 and 30 which are foldably coupled to each other by a main coupling part 10. Front and back collapsing covers 25 and 35 are coupled, respectively, to the upper surfaces of the front and back covers 20 and 30 by corresponding separation lines 25a and 35a, in such a way as to overlap the front and back covers 20 and 30. Angle holding units 40 are provided between the front cover 20 and the front collapsing cover 25 and between the back cover 30 and the back collapsing cover 35 to hold an angle between the front cover 20 and the front collapsing cover 25 and an angle between the back cover 30 and the back collapsing cover 35.

As shown in FIG. 3, a detachable support unit 60 is provided on any one of the main coupling part 10 and the front and back covers 20 and 30, and functions to detachably support a page unit (not shown) on which various pieces of information may be printed or on which a memo may be taken.

As shown in the drawings, the separation line 25a which couples the front collapsing cover 25 to the front cover 20 is formed on the upper portion of the front cover 20, and the separation line 35a which couples the back collapsing cover 35 to the back cover 30 is formed on the upper portion of the back cover 30. Of course, the separation lines 25a and 35a may be formed, respectively, on the uppermost end of the front cover 20 and the uppermost end of the back cover 30.

The main coupling part 10 is connected at opposite side edges thereof to the front cover 20 and the back cover 30 via separation lines 10a.

The front cover 20 has a stepped surface 20a which is thinner than the front cover, and the back cover 30 has a stepped surface 30a which is thinner than the back cover.

The front collapsing cover 25 fits inside the stepped surface 20a, and is connected to the front cover 20 via the separation line 25a. Here, the thickness of the front collapsing cover 25 is determined such that the total thickness of the overlapping stepped surface 20a and front collapsing cover 25, when the front collapsing cover fits inside the stepped surface 20a, is the same as the thickness of the front cover 20.

The back collapsing cover 35 fits inside the stepped surface 30a, and is connected to the back cover 30 via the separation line 35a. Here, the thickness of the back collapsing cover 35 is determined such that the total thickness of the overlapping stepped surface 30a and back collapsing cover 35, when the back collapsing cover fits inside the stepped surface 30a, is the same as the thickness of the back cover 30.

Here, the front collapsing cover 25 and the back collapsing cover 35 are coupled to a subsidiary coupling part 15 via separation lines 25b and 35b.

Detachable attaching parts 26a and 26b are provided on the corners of the front cover 20 and the front collapsing cover 25 to maintain the overlapping state of the front collapsing cover 25 with the front cover 20. Further, detachable attaching parts 36a and 36b are provided on the corners of the back cover 30 and the back collapsing cover 35 to maintain the overlapping state of the back collapsing cover 35 with the back cover 30. The detachable attaching parts 26a and 26b or 36a and 36b may comprise Velcro fasteners so that they are detachably attached to each other, or comprise a magnet and a steel piece which are detachably attached to each other using magnetic force, or comprise magnets which are arranged such that opposite poles face each other, non-magnetic buttons, etc.

The front cover 20 and the back cover 30 are manufactured through injection molding using polypropylene (so-called PP), which is relatively strong and cheap, or are made of acryl, paper like a hard board, plastics, aluminum, wood, etc, because each of the front and back covers requires predetermined strength so as to be erected on a table. Further, in order to provide a luxury effect, the front and back covers 20 and 30 may be covered with natural leather, synthetic leather, or cloth, and corners of each of the front and back covers may be rounded.

In order to erect the eye protective cover capable of supporting multi-purpose contents according to the present invention, angle holding units are provided between the front cover 20 and the front collapsing cover 25 and the back cover 30 and the back collapsing cover 35 to hold angles therebetween. The angle holding units may be embodied in various shapes, which will be described below in detail.

As shown in FIGS. 2 and 3, angle holding units 40 and 50 according to the first embodiment comprise band members which are connected between the front cover 20 and the front collapsing cover 25 and between the back cover 30 and the back collapsing cover 35.

FIG. 4 is a view illustrating a second embodiment of an angle holding unit for holding an angle between the front or back cover and the corresponding front or back collapsing cover in the eye protective cover of FIG. 1.

As shown in the drawing, angle holding units 140 according to the second embodiment connect the whole portion of an edge of the front cover 20 to the whole portion of an edge of the front collapsing cover 25, and connect the whole portion of an edge of the back cover 30 to the whole portion of an edge of the back collapsing cover 35. Each angle holding unit may comprise a sheet member which has a folding line along the center of the sheet member so that it is foldable.

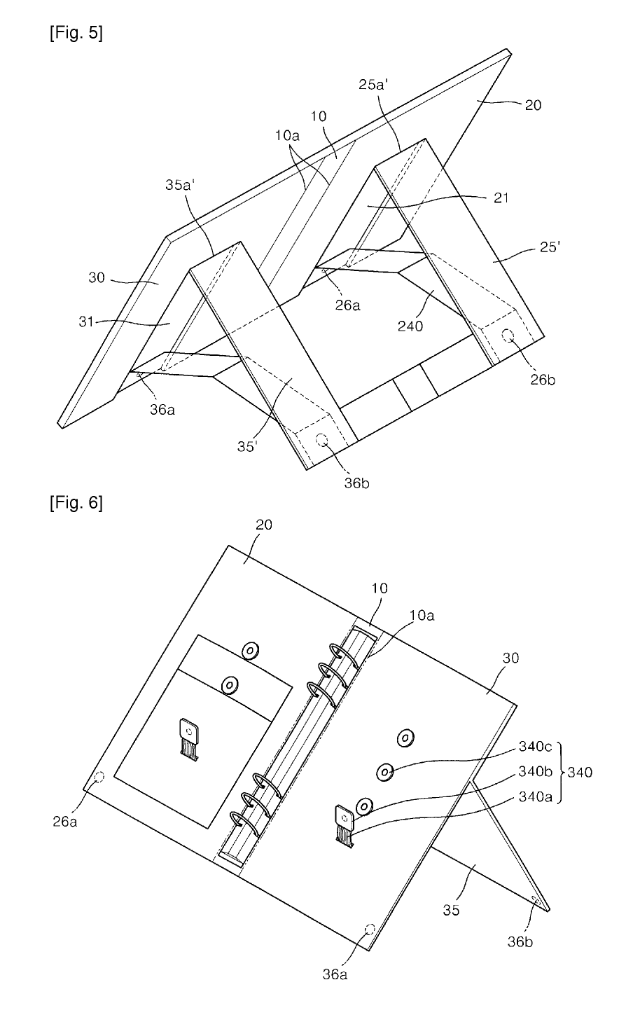

FIG. 5 is a view illustrating a third embodiment of an angle holding unit for holding an angle between the front or back cover and the corresponding front or back collapsing cover in the eye protective cover of FIG. 1.

As shown in the drawing, front and back cover grooves 21 and 31 are formed in the corresponding front and back covers 20 and 30. A front collapsing cover 25′ is a member which is connected to the upper edge of the front cover groove 21 via a separation line 25a′ and is fitted into the front cover groove 21. A back collapsing cover 35′ is a member which is connected to the upper edge of the back cover groove 31 via a separation line 35a′ and is fitted into the back cover groove 31. Here, the angle holding units 240 according to the third embodiment are band members which are provided between the front cover groove 21 and the front collapsing cover 25′ and between the back cover groove 31 and the back collapsing cover 35′.

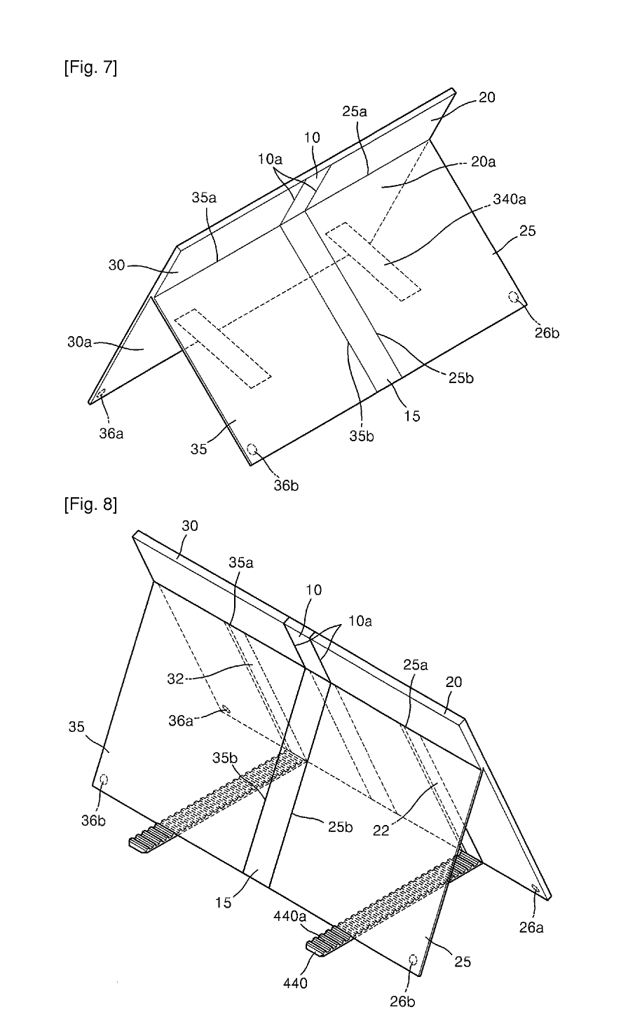

FIGS. 6 and 7 are views illustrating a fourth embodiment of an angle holding unit for holding an angle between the front or back cover and the corresponding front or back collapsing cover in the eye protective cover of FIG. 1.

As shown in the drawings, an angle holding unit 340 according to the fourth embodiment includes a band member 340a, first detachable attaching parts 340b, and a second detachable attaching part 340c. The band member is connected to each of the front and back collapsing covers 25 and 35 and is supported at the lower portion of each of the front and back covers 20 and 30. The first detachable attaching parts are provided on the upper portion of each of the front and back covers 20 and 30 at regular intervals. The second detachable attaching part is installed at the band member 340a to be detachably attached to an associated first detachable attaching part 340b.

The band member 350a has the shape of a band, and is made of cloth, plastics, polymer resin, leather, paper, etc. Further, the first and second detachable attaching parts 350b and 350c may comprise Velcro fasteners so that they are detachably attached to each other, or comprise a magnet and a steel piece which are detachably attached to each other using magnetic force, or comprise magnets which are arranged such that opposite poles face each other, non-magnetic buttons, etc.

Here, the band member 340a or 350a may pass through a through hole (not shown) formed in the lower portion of the front or back cover 20 or 30, or may be held on the lower or side end of the front or back cover 20 or 30.

FIG. 8 is a view illustrating a fifth embodiment of an angle holding unit for holding an angle between the front or back cover and the corresponding front or back collapsing cover in the eye protective cover of FIG. 1.

As shown in the drawing, angle holding units 440 according to the fifth embodiment are foldably coupled to the lower edges of the front and back covers 20 and 30, respectively. Each angle holding unit includes a plurality of fitting grooves 440a such that an edge of each of the front and back collapsing covers 25 and 35 is fitted into an associated fitting groove. Preferably, angle-holding-unit insertion grooves 22 and 32 are provided, respectively, in the front cover 20 and the back cover 30 so that each angle holding unit 440 is fitted into the corresponding angle-holding-unit insertion groove. Meanwhile, in the drawing, each angle holding unit 440 is positioned between the front cover 20 and the front collapsing cover 25 or between the back cover 30 and the back collapsing cover 35. However, when each angle holding unit is not in use, the angle holding unit may overlap a surface of the front or back cover 20 or 30.

In such a construction, the erection angle of the eye protective cover capable of supporting multi-purpose contents is changed according to the position of a specific fitting groove 440a into which an edge of the front or back collapsing cover 25 or 35 is fitted.

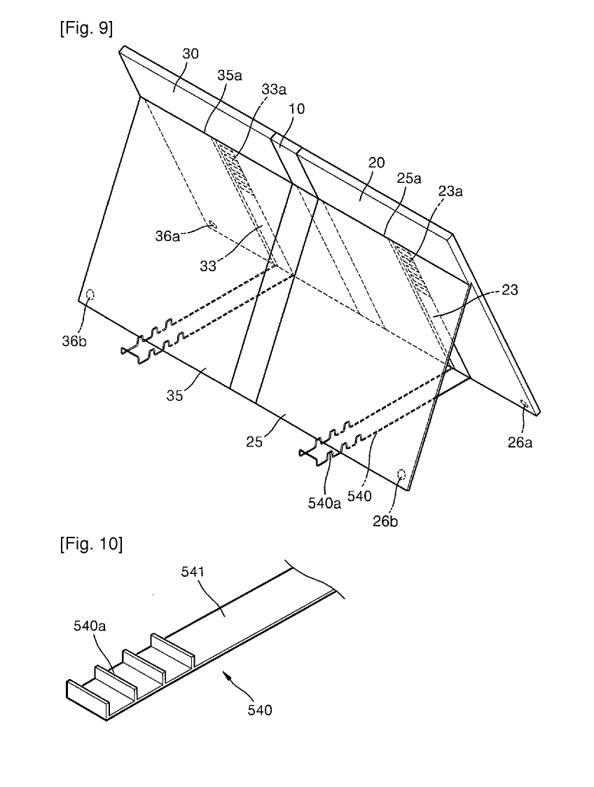

FIGS. 9 and 10 are views illustrating a sixth embodiment of an angle holding unit for holding an angle between the front or back cover and the corresponding front or back collapsing cover in the eye protective cover of FIG. 1.

As shown in the drawings, angle holding units 540 according to the sixth embodiment are foldably coupled to the lower edges of the front and back covers 20 and 30, respectively. Each angle holding unit includes a plurality of support protrusions 540a for supporting an edge of the front or back collapsing cover 25 or 35. Here, an angle-holding-unit insertion groove is formed in each of the front and back covers 20 or formed in each of the front and back collapsing covers 25 and 35 so that the angle holding unit 540 is inserted into the angle-holding-unit insertion groove. Protrusion fitting holes may be formed in the angle-holding-unit insertion groove so that support protrusions 540a are fitted into the corresponding protrusion fitting holes. According to this embodiment, the angle-holding-unit insertion grooves 23 and 33 are formed, respectively, in the back surfaces of the front and back covers 20 and 30, and the protrusion fitting holes 23a and 33a are formed in the corresponding angle-holding-unit insertion grooves 23 and 33.

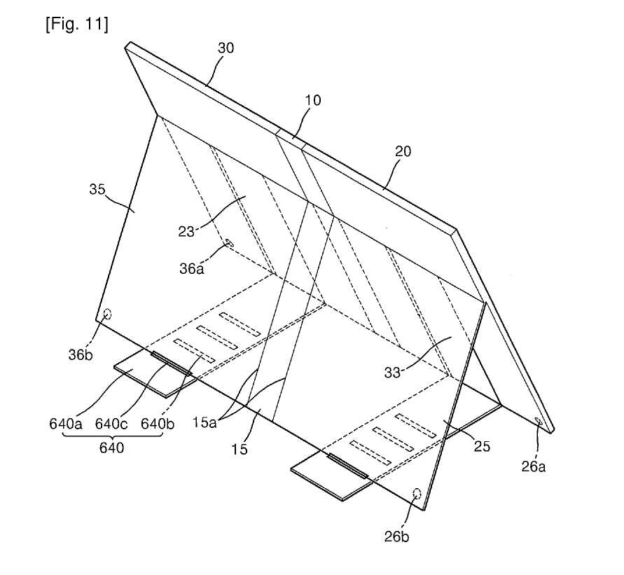

Each angle holding unit 540 has a rectangular shape, and may be formed using wires such that the support protrusions 540a are provided on the angle holding unit. Further, as shown in FIG. 11, an angle holding unit 540 may be produced by separately manufacturing the rectangular plate 541 and support protrusions 540a′ and thereafter attaching the support protrusions to the plate through welding. Of course, each angle holding unit 540 may be manufactured such that grooves may be formed in the plate 541, and thereby an edge of the front or back collapsing cover 25 or 35 is fitted into the associated groove. Meanwhile, as shown in the drawing, each angle holding unit 540 is positioned between the front cover 20 and the front collapsing cover 25 or between the back cover 30 and the back collapsing cover 35. However, when each angle holding unit is not in use, the angle holding unit may overlap a surface of the front or back cover 20 or 30.

In such a construction, the erection angle of the eye protective cover capable of supporting multi-purpose contents is changed according to the position of a specific fitting groove 540a or 540a′ into which an edge of the front or back collapsing cover 25 or 35 is fitted.

FIG. 11 is a view illustrating a seventh embodiment of an angle holding unit for holding an angle between the front or back cover and the corresponding front or back collapsing cover in the eye protective cover of FIG. 1.

As shown in the drawing, an angle holding unit 640 according to the seventh embodiment includes a plate member 640a and a second magnetic detachable attaching part 640c. The plate member is foldably connected to the lower edge of the front or back cover 20 or 30, and first magnetic detachable attaching parts 640b are embedded in the plate member in such a way as to be arranged at predetermined intervals. The second magnetic detachable attaching part is embedded in an end of each of the front and back collapsing covers 25 and 35 to be detachably attached to an associated first magnetic detachable attaching part 640b. Here, an angle-holding-unit insertion groove 23 or 33 is formed in the front or back cover 20 or 30 so that each angle holding unit 640 is inserted into the angle-holding-unit insertion groove. Of course, the plate member 640a having the second magnetic detachable attaching part 640c may be protruded or recessed. Meanwhile, as shown in the drawing, the angle holding unit 640 is positioned between the front cover 20 and the front collapsing cover 25 or between the back cover 30 and the back collapsing cover 35. However, when each angle holding unit is not in use, the angle holding unit may overlap each of the front and back covers 20 and 30.

In such a construction, the erection angle of the eye protective cover capable of supporting multi-purpose contents is changed according to the position of the first magnetic detachable attaching part 640b to which the second magnetic detachable attaching part 640c is attached.

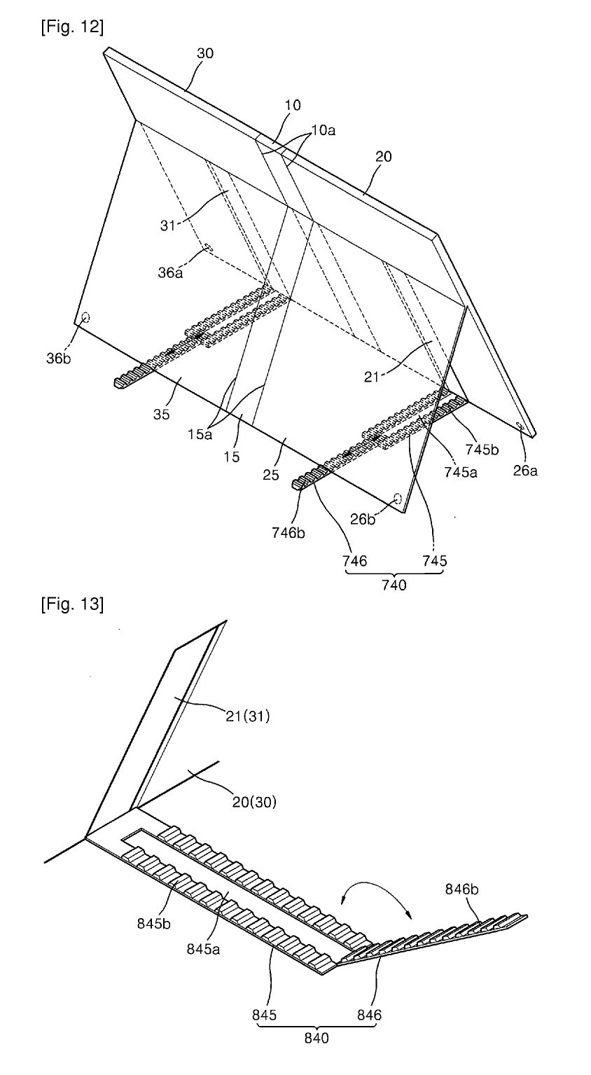

FIG. 12 is a view illustrating an eighth embodiment of an angle holding unit for holding an angle between the front or back cover and the corresponding front or back collapsing cover in the eye protective cover of FIG. 1.

As shown in the drawing, an angle holding unit 740 according to the eighth embodiment includes a body 745 and a slider 746. The body is foldably connected to the lower edge of each of the front and back covers 20 and 30. A guide groove 745a is provided in the body, and a plurality of first support protrusions 745b is provided on the upper surface of the body such that the edge of each of the front and back collapsing covers 25 and 35 is supported by an associated first support protrusion. The slider slides along the guide groove 745a, and has on the upper surface thereof a plurality of second support protrusions 746b such that the edge of each of the front and back collapsing covers 25 and 35 is supported by an associated second support protrusion. In such a construction, the slider 746 slides from an edge of the body 745 to each of the front and back collapsing covers 25 and 35. In this state, an edge of each of the front and back collapsing covers 25 and 35 is supported by an associated first or second support protrusion 745b or 746b. According to the position of the first or second support protrusion 745b or 746b to which the edge of each of the front and back collapsing covers is supported, the erection angle of the eye protective cover capable of supporting multi-purpose contents is changed. Meanwhile, as shown in the drawing, the angle holding unit 740 is positioned between the front cover 20 and the front collapsing cover 25 or between the back cover 30 and the back collapsing cover 35. However, when each angle holding unit is not in use, the angle holding unit may be superposed on each of the front and back covers 20 and 30.

FIG. 13 is a view illustrating a ninth embodiment of an angle holding unit for holding an angle between the front or back cover and the corresponding front or back collapsing cover in the eye protective cover of FIG. 1.

As shown in the drawing, an angle holding unit 840 according to the ninth embodiment includes a body 845 and a rotary bar 846. The body is foldably connected to the lower edge of each of the front and back covers 20 and 30. A guide groove 845a is provided in the body, and a plurality of first support protrusions 845b is provided on the upper surface of the body so that the edge of each of the front and back collapsing covers 25 and 35 is supported by an associated first support protrusion. The rotary bar is rotatably installed at an edge of the guide groove 845a such that the rotary bar is retracted into or extended from the guide groove 845a. A plurality of second support protrusions 846b is provided on the upper surface of the rotary bar to support the edge of each of the front and back collapsing covers 25 and 35. In such a construction, the rotary bar 846 rotates in a direction from an edge of the body 845 to each of the front and back collapsing covers 25 and 35. In this state, an edge of each of the front and back collapsing covers 25 and 35 is supported by an associated first or second support protrusion 845b or 846b. According to the position of the first or second support protrusion 845b or 846b to which the edge of each of the front and back collapsing covers is supported, the erection angle of the eye protective cover capable of supporting multi-purpose contents is changed.

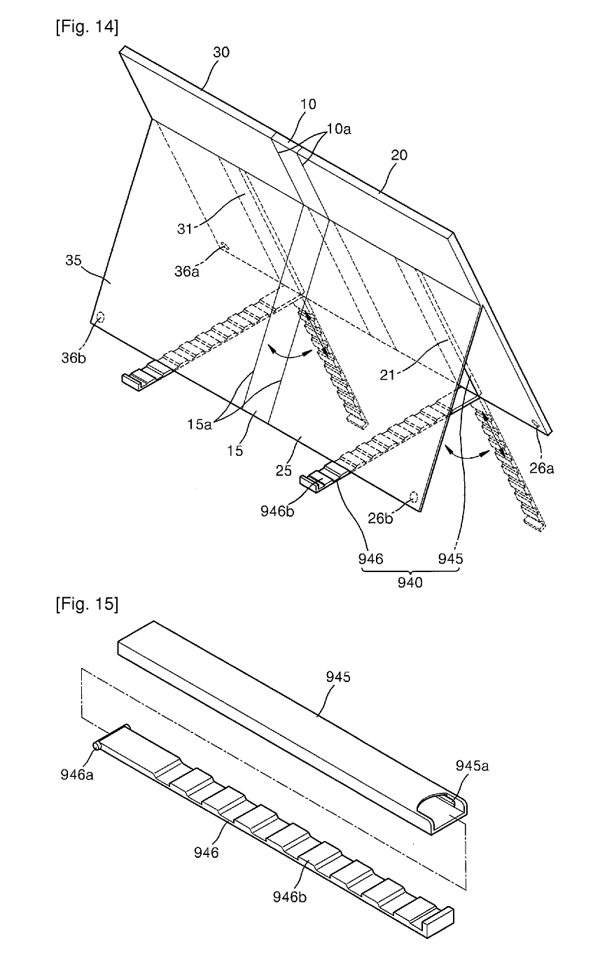

FIG. 14 is a view illustrating a tenth embodiment of an angle holding unit for holding an angle between the front or back cover and the corresponding front or back collapsing cover in the eye protective cover of FIG. 1, and FIG. 15 is a detailed view illustrating the angle holding unit of FIG. 14.

As shown in the drawings, an angle holding unit 940 according to the tenth embodiment includes a guide pipe 945 and a slider 946. The guide pipe is provided vertically in each of the front and back covers 20 and 30. A removal prevention step 945a is provided in an end of the guide pipe. The slider slides in the guide pipe 945, and has a removal prevention projection 946a which is locked by the removal prevention step 945a. A plurality of support protrusions 946b is formed on the upper surface of the slider to support an edge of each of the front and back collapsing covers 25 and 35. In such a construction, after the slider 956 protrudes out from the guide pipe 945, the removal prevention projection 946a is stopped by the removal prevention step 945a. In this state, the slider rotates to each of the front and back collapsing covers 25 and 35. An end of each of the front and back collapsing covers 25 and 35 is supported by an associated support protrusion 946b. Here, according to the position of the support protrusion 946b to which each of the front and back collapsing covers is supported, the erection angle of the eye protective cover capable of supporting multi-purpose contents is changed.

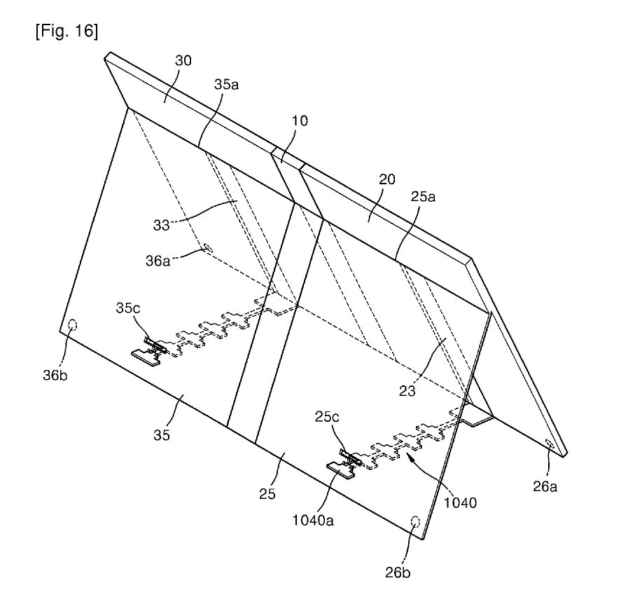

FIG. 16 is a view illustrating an eleventh embodiment of an angle holding unit for holding an angle between the front or back cover and the corresponding front or back collapsing cover in the eye protective cover of FIG. 1.

As shown in the drawing, an angle holding unit 1040 according to the eleventh embodiment is foldably connected to the lower edge of each of the front and back covers 20 and 30, and is a member having a plurality of locking protrusions 1040a which are fitted into a perforation hole 25c or 35c formed in the corresponding front or back collapsing cover 25 or 35. Of course, the locking protrusions 1040a and the perforation hole 25c and 35c may have various shapes. In such a construction, according to the position of an associated locking protrusion 1040a fitted into the perforation hole 25c or 35c, the erection angle of the eye protective cover capable of supporting multi-purpose contents is changed.

As described above, various types of angle holding units may be possible. Further, the angle holding unit may have various length locking or extending structures.

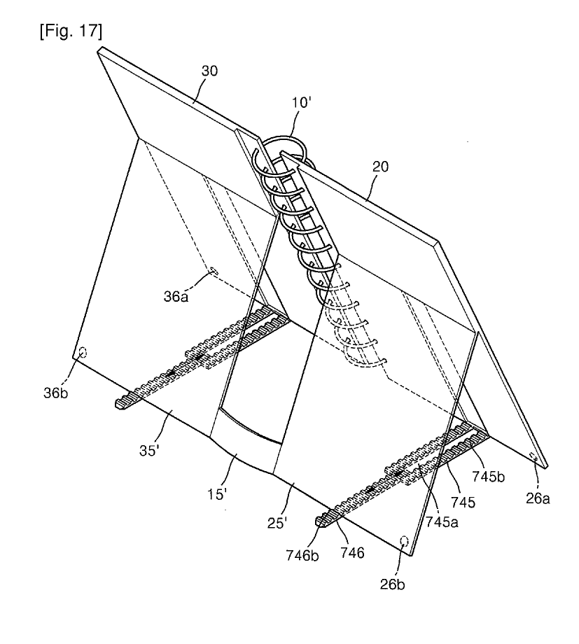

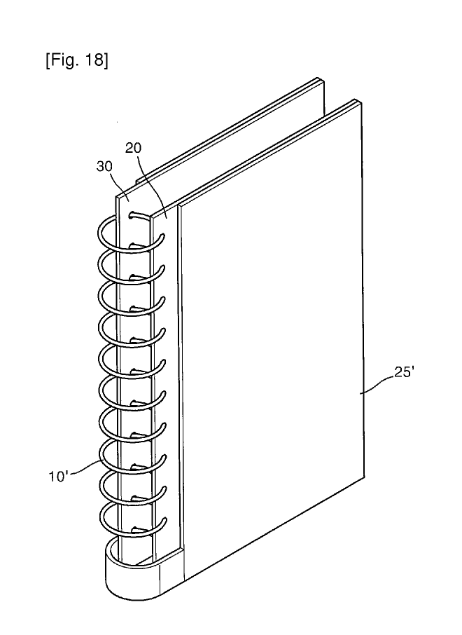

FIG. 17 is a view illustrating a main coupling part of the eye protective cover of FIG. 1, in which the main coupling part comprises a plurality of rings, FIG. 17 is a view illustrating the state in which the eye protective of FIG. 16 is closed like a book, and FIG. 18 is a view illustrating the front collapsing cover and the back collapsing cover which are separated from each other.

The main coupling part 10, described with reference to FIGS. 1 to 16, is directly connected to the side edges of the front and back covers 20 and 30. However, as shown in FIG. 17, a main coupling part 10′ may comprise a plurality of rings which couples the front cover 20 with the back cover 30. In this case, front and back collapsing covers 25′ and 35′ are separated from each other so as to prevent the interference of the front and back collapsing covers with the main coupling part 10′ comprising the rings. The front and back collapsing covers 25′ and 35′ are overlapped, respectively, with the front and back covers provided on both sides of the main coupling part 10′.

Meanwhile, as shown in FIG. 17, the lower end of the front collapsing cover 25′ and the lower end of the back collapsing cover 35′ may be coupled to each other via a convex coupling band 15′. Moreover, the front cover 10 and the back cover 20 may be also coupled to each other via a coupling bond (not shown). In this case, the coupling bond may completely or partially couple the front and back covers 10 and 20 with each other.

In this construction, as shown in FIG. 18, when the front and back collapsing covers 25′ and 35′ are superposed on the front and back covers 20 and 30, the eye protective cover capable of supporting multi-purpose contents according to the present invention forms the shape of a book.

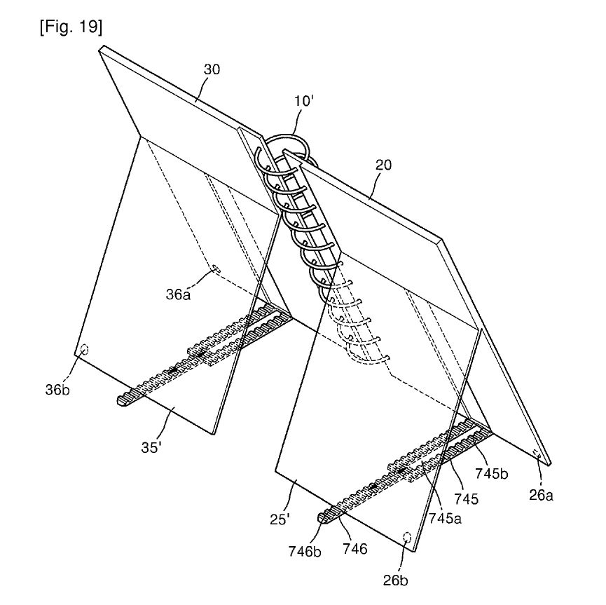

Meanwhile, as shown in FIG. 19, the coupling band 15′ of FIGS. 17 and 18 may not be provided between the front collapsing cover 25′ and the back collapsing cover 35′. In this case, the erection angles of the front and back collapsing covers 25′ and 35′ can be independently controlled using the corresponding angle holding units.

FIG. 20 is a view illustrating a subsidiary coupling part provided on each of the upper and lower ends of the front and back collapsing covers.

As shown in the drawing, a main coupling part 10″ may comprise a spring binding the front cover 20 and the back cover 30, which cover the front and back of a page unit on which various pieces of information may be printed or on which a memo may be taken. Here, a subsidiary coupling band 15′ may be provided 8 on the upper or lower ends of the front and back collapsing covers 25 and 35 to couple the front and back collapsing covers to each other.

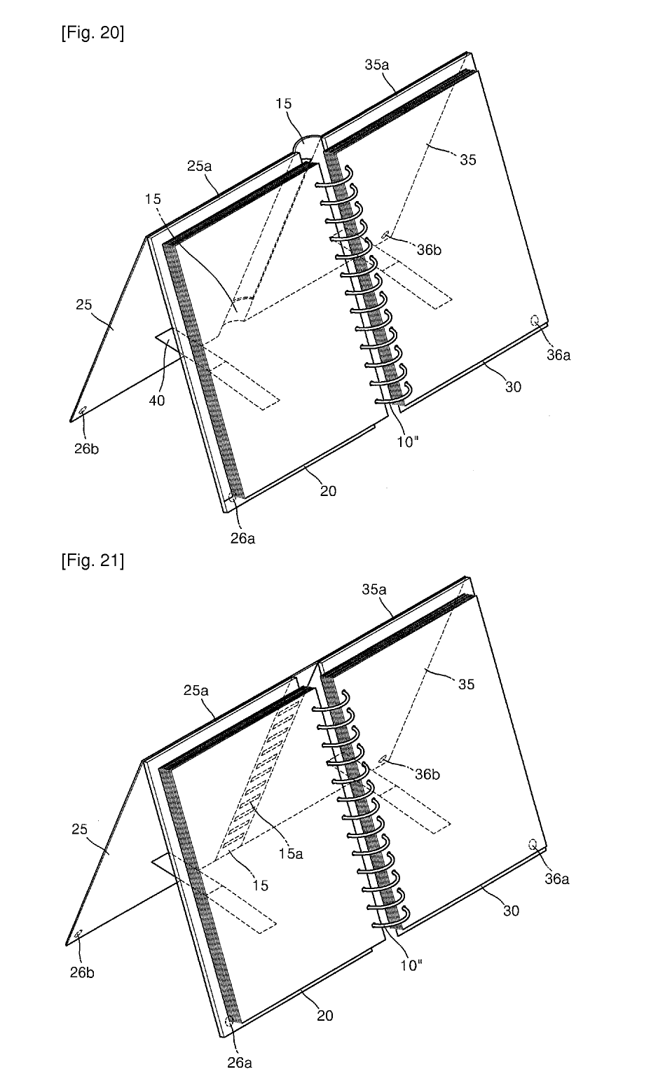

FIG. 21 is a view illustrating holes formed in a subsidiary coupling part.

As shown in the drawing, a main coupling part 10″ may comprise a spring binding the front cover 20 and the back cover 30, which cover the front and back of a page unit on which various pieces of information may be printed or on which a memo may be taken. Here, holes 15a are formed in the subsidiary coupling part 15 which couples the front collapsing cover 25 with the back collapsing cover 35, so that part of the spring, which is the main coupling part, is inserted into the holes. In this construction, when the front and back collapsing covers 25 and 35 overlap the front and back covers 20 and 30, part of the spring, which is the main coupling part 10″, is exposed to the outside through the holes 15a.

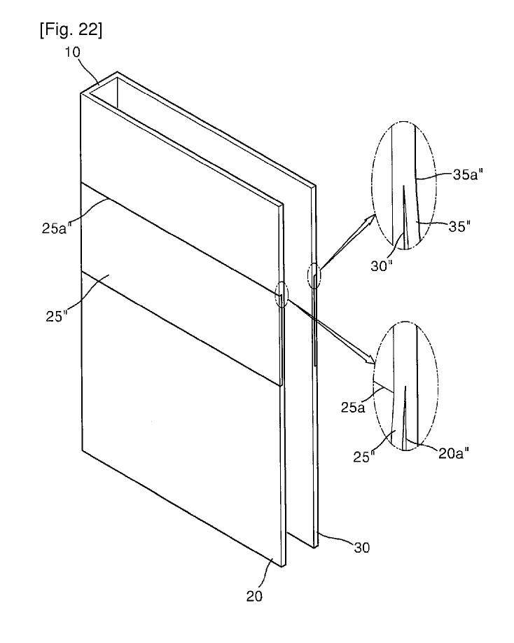

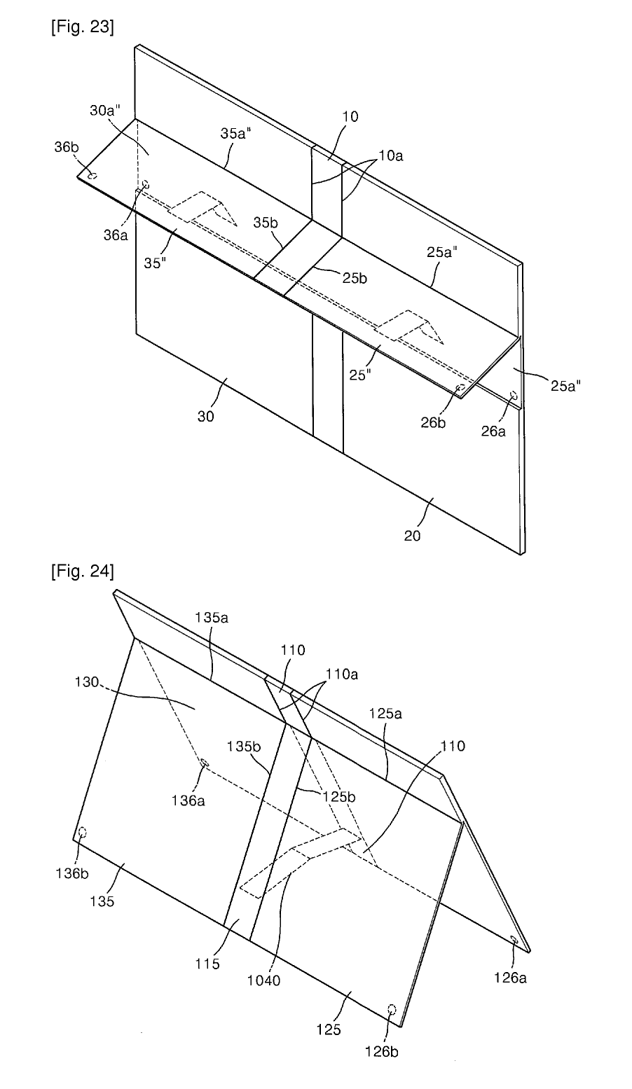

FIGS. 22 and 23 are views illustrating the front and back collapsing covers fitting inside the corresponding front and back covers.

As shown in the drawings, a front collapsing cover 25″ may fit inside the front cover 20, and a back collapsing cover 35″ may fit inside the back cover 30. To this end, front and back cover holding recesses 20a″ and 30a″ are formed, respectively, in the front and back covers 20 and 30 so that front and back collapsing covers 25″ and 35″ fit inside the corresponding recesses. The front and back cover holding recesses 20a″ and 30a″ are thinner than the corresponding front and back covers 20 and 30. When the front or back collapsing cover 25″ or 35″ fits inside the corresponding front or back cover holding recess 20a″ and 30a″, the total thickness is the same as that of the front or back cover 20 or 30.

Detachable attaching parts 26a and 26b are installed to the front collapsing cover 25″ and the front cover holding recess 20a″ so as to maintain the overlapping state of the front collapsing cover 25″ with the front cover holding recess 20a″, and detachable attaching parts 36a and 36b are installed to the back collapsing cover 35″ and the back cover holding recess 30a″ so as to maintain the overlapping state of the back collapsing cover 35″ with the back cover holding recess 30a″.

The detachable support unit 60 functions to detachably support the page unit, and may be embodied in various shapes. For example, the detachable support unit may comprise a binder which is mounted to the main coupling part 10 to bind a page unit (not shown) having several pages. Further, the detachable support unit may comprise a plurality of vinyl bags which is connected to the main coupling part 10 to receive paper. Further, the detachable support unit may comprise a clip which is installed at the upper end of the front or back cover to detachably support the upper end of the page unit.

An eye protective cover capable of supporting multi-purpose contents according to the second embodiment of the present invention will be described below.

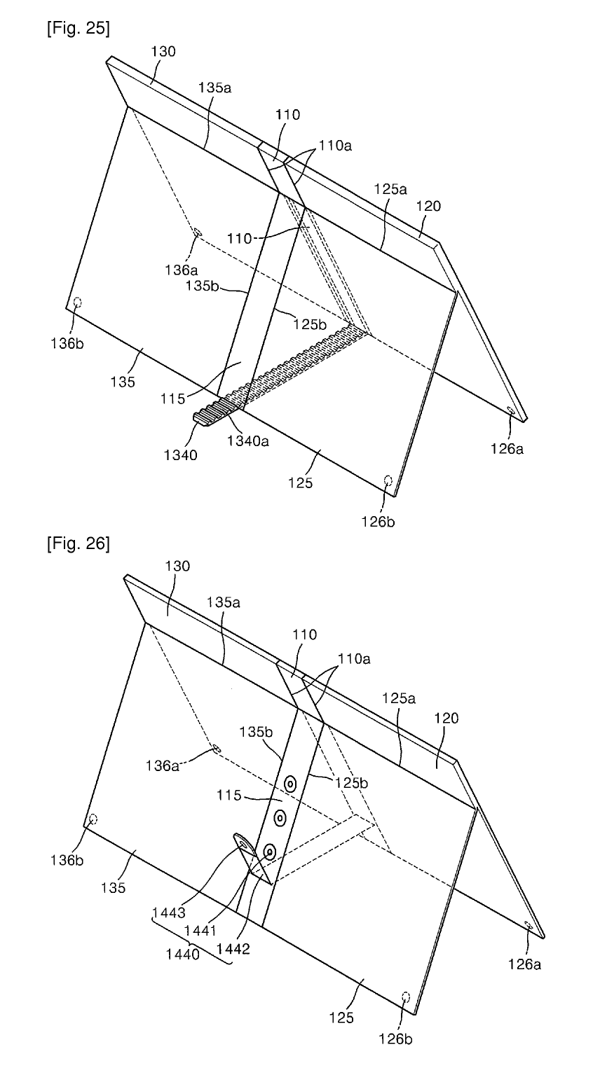

FIG. 24 is a perspective view illustrating an eye protective cover capable of supporting multi-purpose contents according to a second embodiment of the present invention, in which the eye protective cover has an angle holding unit of a first embodiment, FIG. 25 is a view illustrating an angle holding unit of a second embodiment in the eye protective cover of FIG. 24, and FIG. 26 is a view illustrating an angle holding unit of a third embodiment in the eye protective cover of FIG. 24.

As shown in the drawings, an eye protective cover capable of supporting multi-purpose contents according to the second embodiment includes front and back covers 120 and 130 which are foldably coupled to each other by a main coupling part 110. A front collapsing cover 125 is connected to the upper portion of the front cover 120 via a separation line 125a, thus overlapping the front cover 120. A back collapsing cover 135 is connected to the upper portion of the back cover 130 via a separation line 135a, thus overlapping the back cover 130. A subsidiary coupling part 115 couples the front collapsing cover 125 with the back collapsing cover 135. An angle holding unit is connected between the subsidiary coupling part 115 and the main coupling part 110, thus holding an angle between the front cover 20 and the front collapsing cover 125 and an angle between the back cover 130 and the back collapsing cover 135.

Here, as shown in FIG. 3, a detachable support unit 160 is mounted on any one of the main coupling part 10 and the front and back covers 20 and 30, and detachably supports a page unit (not shown) on which various pieces of information are printed or on which a memo may be taken. The detachable support unit 160 is similar to that of the first embodiment.

Since the front cover 120 and the back cover 130 are very similar to the front cover 20 and the back cover 30 according to the first embodiment, the detailed description of the front and back covers will be omitted. Further, as in the first embodiment, separation lines 125a and 135a may be formed on the upper portions or the uppermost ends of the front and back covers.

A subsidiary coupling part 115 couples the front collapsing cover 125 with the back collapsing cover 135 using separation lines 125b and 135b. Here, the subsidiary coupling part 115 may completely or partially couple the front collapsing cover 125 with the back collapsing cover 135.

Detachable attaching parts 126a and 126b are provided on the corners of the front cover 120 and the front collapsing cover 125 to maintain the overlapping state of the front collapsing cover 125 with the front cover 120. Further, detachable attaching parts 136a and 136b are provided on the corners of the back cover 130 and the back collapsing cover 135 to maintain the overlapping state of the back collapsing cover 135 with the back cover 130. The detachable attaching parts 126a and 126b or 136a and 136b comprise Velcro fasteners so that they are detachably attached to each other, or comprise a magnet and a steel piece which are detachably attached to each other using magnetic force, or comprise magnets which are arranged such that opposite poles face each other, non-magnetic buttons, etc.

In order to erect the eye protective cover capable of supporting multi-purpose contents according to the present invention, an angle holding unit is installed between the front or back collapsing cover 125 or 135 and the corresponding front or back cover 120 or 130 to hold an angle between the front collapsing cover and the front cover or an angle between the back collapsing cover and the back cover. The angle holding unit may be embodied in various shapes, which will be described below.

As shown in FIG. 24, an angle holding unit 1240 according to the first embodiment is a band member which is provided between the main coupling part 110 with the subsidiary coupling part 115 to couple the main and subsidiary coupling parts to each other.

As shown in FIG. 25, an angle holding unit 1340 according to the second embodiment is a member which is foldably coupled to the lower edge of the main coupling part 110 and has a plurality of fitting grooves 1340a such that an edge of the subsidiary coupling part 115 is fitted into an associated fitting groove. The fitting grooves 1340a are formed in the angle holding unit 1340 so that an edge of the subsidiary coupling part 115 coupling the front and back collapsing covers 125 and 135 to each other is fitted into an associated fitting groove. According to the position of the fitting groove into which the edge of the subsidiary coupling part is fitted, the erection angle of the front and back covers 120 and 130 is changed. In the drawing, the angle holding unit 1340 is positioned between the main coupling part 110 and the subsidiary coupling part 115. However, when the angle holding unit is not in use, the angle holding unit may overlap a surface of the main coupling part 110.

As shown in FIG. 26, an angle holding unit 1440 according to the third embodiment includes a plurality of first detachable attaching parts 1441, a band member 1442, and a second detachable attaching part 1443. The first detachable attaching parts are mounted on the subsidiary coupling part 115 at predetermined intervals. The band member is connected to the main coupling part 110 in such a way as to pass through a lower portion of the subsidiary coupling part 115. The second detachable attaching part 1443 is installed at an end of the band member 1442 to be attached to an associated first detachable attaching part 1441.

As the second detachable attaching part 1443 is attached to a first detachable attaching part 1441 provided at a specific position, the band member 1442 changes an interval between the front or back cover 120 or 130 and the front or back collapsing cover 125 and 135, and the erection angle between the front and back covers 120 and 130 can be changed.

Here, the first and second detachable attaching parts 1441 and 1443 may comprise Velcro fasteners so that they are detachably attached to each other, or comprise a magnet and a steel piece which are detachably attached to each other using magnetic force, or comprise magnets which are arranged such that opposite poles face each other. According to this embodiment, the first and second detachable attaching parts 1441 and 1443 comprise a steel piece mounted on the band member 1442 and button-shaped magnets mounted on the subsidiary coupling part 115. Further, the band member may be made of various materials, for example, cloth, plastics, polymer resin, leather, paper, etc.

In order to prevent the angle holding unit 1440 from being exposed outside, a cap may be provided on the subsidiary coupling part 115 to cover the angle holding unit 1440.

Further, in this embodiment, the first and second detachable attaching parts 1441 and 1443 of the angle holding unit 1440 are provided on the subsidiary coupling part 115. However, the first and second detachable attaching parts may be installed at the main coupling part 110, and the band member 1442 may be coupled to the subsidiary coupling part 115.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An eye protective cover capable of supporting multi-purpose contents, comprising:
front and back covers (20 and 30) foldably coupled to each other by a main coupling part (10);
front and back collapsing covers (25 and 35) coupled, respectively, to upper surfaces of the front and back covers (20 and 30) by separation lines (25a and 35a) in such a way as to overlap the front and back covers (20 and 30); and
an angle holding unit provided between the front or back cover (20 or 30) and the corresponding front or back collapsing cover (25 or 35) to hold an angle between the front or back cover (20 or 30) and the corresponding front or back collapsing cover (25 or 35).

2. The eye protective cover capable of supporting multi-purpose contents according to claim 1, wherein the angle holding unit (140) comprises a sheet member which connects a whole portion of an edge of the front or back cover (20 or 30) to a whole portion of an edge of the corresponding front or back collapsing cover (25 or 35), and has at a center thereof a folding line such that the sheet member is folded along the folding line.

3. The eye protective cover capable of supporting multi-purpose contents according to claim 1, wherein a front or back cover groove (21 or 31) is formed in the corresponding front or back cover (20 or 30), and the front collapsing cover (25′) is a member which is connected to an upper edge of the front cover groove (21) via a separation line (25a′) and is fitted into the front cover groove (21), and the back collapsing cover (35′) is a member which is connected to an upper edge of the back cover groove (31) via a separation line (35a′) and is fitted into the back cover groove (31), and the angle holding unit (240) is a band member which is installed between the front or back cover groove (21 or 31) and the corresponding front or back collapsing cover (25′ or 35′).

4. The eye protective cover capable of supporting multi-purpose contents according to claim 1, wherein the angle holding unit (340) comprises:
a band member (340a) connected to the front or back collapsing cover (25 or 35) and supported at a lower portion of the front or back cover (20 or 30);
first detachable attaching parts (340b) provided on an upper portion of the front or back cover (20 or 30) at regular intervals; and
a second detachable attaching part (340c) installed at the band member (340a) to be detachably attached to an associated first detachable attaching part (340b).

5. The eye protective cover capable of supporting multi-purpose contents according to claim 1, wherein the angle holding unit (440) is a member which is foldably connected to a lower edge of the front or back cover (20 or 30) and includes a plurality of fitting grooves (440a) such that an edge of the front or back collapsing cover (25 or 35) is fitted into an associated fitting groove.

6. The eye protective cover capable of supporting multi-purpose contents according to claim 1, wherein a plurality of protrusion fitting holes (23a or 33a) is formed in a back surface of the front or back cover (20 or 30); and
the angle holding unit (540) is a member which is foldably connected to the lower edge of the front or back cover (20 or 30) and has a plurality of support protrusions (540a) such that an edge of the front or back collapsing cover (25 or 35) is supported by an associated fitting protrusion, or the support protrusions are fitted into the corresponding protrusion fitting holes (23a or 33a) of the front or back cover.

7. The eye protective cover capable of supporting multi-purpose contents according to claim 1, wherein the angle holding unit (640) comprises
a plate member (640a) foldably connected to the lower edge of the front or back cover (20 or 30), with first magnetic detachable attaching part (640b) being embedded in the plate member and arranged at predetermined intervals; and
a second magnetic detachable attaching part (640c) embedded in an end of the front or back collapsing cover (25 or 35) to be detachably attached to an associated first magnetic detachable attaching part (640b).

8. The eye protective cover capable of supporting multi-purpose contents according to claim 1, wherein the angle holding unit (740) comprises:
a body (745) foldably connected to the lower edge of the front or back cover (20 or 30), with a guide groove (745a) being provided in the body and a plurality of first support protrusions (745b) being provided on an upper surface of the body so that the edge of the front or back collapsing cover (25 or 35) is supported by an associated first support protrusion, and
a slider (746) sliding along the guide groove (745a), and having on an upper surface thereof a plurality of second support protrusions (746b) so that the edge of the front or back collapsing cover (25 or 35) is supported by an associated second support protrusion.

9. The eye protective cover capable of supporting multi-purpose contents according to claim 1, wherein the angle holding unit (840) comprises:
a body (845) foldably connected to the lower edge of the front or back cover (20 or 30), with a guide groove (845a) provided in the body and a plurality of first support protrusions (845b) provided on an upper surface of the body so that the edge of the front or back collapsing cover (25 or 35) is supported by an associated first support protrusion, and
a rotary bar (846) rotatably installed at an edge of the guide groove (845a) such that the rotary bar is retracted into or extended from the guide groove (845a), with a plurality of second support protrusions (846b) provided on an upper surface of the rotary bar to support the edge of the front or back collapsing cover (25 or 35).

10. The eye protective cover capable of supporting multi-purpose contents according to claim 1, wherein the angle holding unit (940) comprises:
a guide pipe (945) provided vertically in the front or back cover (20 or 30), with a removal prevention step (945a) provided in an end of the guide pipe, and
a slider (946) sliding in the guide pipe (945) and having a removal prevention projection (946a) which is locked by the removal prevention step (945a), with a plurality of support protrusions (946b) formed on an upper surface of the slider to support the edge of the front or back collapsing cover (25 or 35).

11. The eye protective cover capable of supporting multi-purpose contents according to claim 1, wherein the angle holding unit (1040) is foldably connected to the lower edge of the front or back cover (20 or 30), and comprises a member having a plurality of locking protrusions (1040a) which are fitted into a perforation hole (25c or 35c) formed in the front or back collapsing cover (25 or 35).

12. The eye protective cover capable of supporting multi-purpose contents according to claim 1, wherein the main coupling part (10′) comprises a plurality of rings for coupling the front cover (20) with the back cover (30); and
the front collapsing cover (25′) and the back collapsing cover (35′) are separated from each other and overlap with the front and back covers provided on both sides of the main coupling part (10′) so as to prevent interference between the front collapsing cover or the back collapsing cover and the main coupling part (10′) comprising the plurality of rings.

13. The eye protective cover capable of supporting multi-purpose contents according to claim 1, wherein the main coupling part (10″) comprises a spring which binds the front cover (20) with the back cover (30); and
a subsidiary coupling band (15′) is provided on upper or lower ends of the front collapsing cover (25) and the back collapsing cover (35) to couple the front and back collapsing covers with each other.

14. The eye protective cover capable of supporting multi-purpose contents according to claim 1, wherein the main coupling part (10″) comprises a spring which binds the front cover (20) with the back cover (30); and
a hole (15a) is formed in the subsidiary coupling part (15) for coupling the front collapsing cover (25) with the back collapsing cover (35) so that part of the spring, which is the main coupling part, is fitted into the hole.

15. The eye protective cover capable of supporting multi-purpose contents according to claim 1, wherein the front collapsing cover (25″) fits inside the front cover (20), and the back collapsing cover (35″) fits inside the back cover (30).

16. The eye protective cover capable of supporting multi-purpose contents according to claim 1, further comprising:
a detachable support unit (60) mounted on the main coupling part (10) or the front or back cover (20 or 30), functioning to detachably support a page unit on which various pieces of information are printed or on which a memo may be taken.

17. The eye protective cover capable of supporting multi-purpose contents according to claim 1, wherein
detachable attaching parts (26a and 26b) are provided on corners of the front cover (20) and the front collapsing cover (25) to maintain an overlapping state of the front collapsing cover (25) with the front cover (20); and
detachable attaching parts (36a and 36b) are provided on corners of the back cover (30) and the back collapsing cover (35) to maintain an overlapping state of the back collapsing cover (35) with the back cover (30).

18. An eye protective cover capable of supporting multi-purpose contents, comprising:
front and back covers (120 and 130) foldably coupled to each other by a main coupling part (110);
a front collapsing cover (125) connected to an upper portion of the front cover (120) via a separation line (125a), thus overlapping the front cover (120);
a back collapsing cover (135) connected to an upper portion of the back cover (130) via a separation line (135a), thus overlapping the back cover (130);
a subsidiary coupling part (115) coupling the front collapsing cover (125) with the back collapsing cover (135); and
an angle holding unit connected between the subsidiary coupling part (115) and the main coupling part (110), thus maintaining an angle between the front cover (20) and the front collapsing cover (125), and an angle between the back cover (130) and the back collapsing cover (135).

19. The eye protective cover capable of supporting multi-purpose contents according to claim 18, wherein
the angle holding unit (1340) is a member which is foldably connected to a lower edge of the main coupling part (110) and has a plurality of fitting grooves (1340a) so that an edge of the subsidiary coupling part (115) is fitted into an associated fitting groove.

20. The eye protective cover capable of supporting multi-purpose contents according to claim 18, wherein the angle holding unit (1440) comprises:
a plurality of first detachable attaching parts (1441) provided on the subsidiary coupling part (115) at predetermined intervals,
a band member (1442) connected to the main coupling part (110) in such a way as to pass through a lower portion of the subsidiary coupling part (115), and
a second detachable attaching part (1443) installed at an end of the band member (1442) to be attached to an associated first detachable attaching part (1441).

21. The eye protective cover capable of supporting multi-purpose contents according to claim 18, further comprising:
a detachable support unit (160) mounted on any one of the main coupling part (110) and the front and back covers (120 and 130), and functioning to detachably support a page unit on which various pieces of information are printed or on which a memo may be taken.

22. The eye protective cover capable of supporting multi-purpose contents according to claim 18, wherein
detachable attaching parts (126a and 126b) are provided on corners of the front cover (120) and the front collapsing cover (125) to maintain an overlapping state of the front collapsing cover (125) with the front cover (120); and
detachable attaching parts (136a and 136b) are provided on corners of the back cover (130) and the back collapsing cover (135) to maintain an overlapping state of the back collapsing cover (135) with the back cover (130).
